(19) United States
(12) Patent Application Publication
(10) Pub. No.: US 2025/0130882 A1
(43) Pub. Date: Apr. 24, 2025

(54) ANOMALOUS BEHAVIOR IDENTIFICATION FROM HOMOGENEOUS DYNAMIC DATA

(71) Applicant: SAP SE, Walldorf (DE)

(72) Inventors: Gaoquan WO, Shanghai (CN); Xiaowei LIAO, Shanghai (CN)

(21) Appl. No.: 18/491,930

(22) Filed: Oct. 23, 2023

(51) Int. Cl. G06F 11/07; G06N 20/00

(52) U.S. Cl. CPC G06F 11/079; G06F 11/0709; G06N 20/00

(57) ABSTRACT

Systems and methods include reception of time-series data of a metric for each of a plurality of computer servers, determination, for each computer server, of a representative value of the metric based on the time-series data of the metric for the computer server, determination, for each computer server, of a fluctuation value of the metric based on the time-series data of the metric for the computer server, determination of a standard value of the metric based on the determined representative values, determination of a standard fluctuation value based on the determined fluctuation values, determination, for each computer server, of a difference value based on a difference between the standard value and the representative value for the computer server and a difference between the standard fluctuation value and the fluctuation value for the computer server; and identification of one or more anomalous computer servers based on the difference values.

### BACKGROUND

Modern organizations often utilize a system landscape consisting of distributed computing systems providing various computing services. For example, in order to implement desired functionality, an organization may deploy services within computing systems located in on-premise data centers (which themselves may be located in disparate geographic locations) and within data centers provided by one or more infrastructure as-a-service (IaaS) providers. Any number of the computing systems may comprise cloud-based systems (e.g., providing services using scalable-on-demand virtual machines).

Purveyors of distributed systems are rapidly adopting cloud-native implementations using containers, microservices, service meshes, and serverless applications. These implementations provide features such as built-in service discovery and load balancing, automated rollouts and rollbacks, and self-healing. However, as computing architectures become more distributed and complex, it becomes more difficult for humans to understand system dependencies, detect system issues and diagnose the root causes of undesirable system behavior.

System landscapes generate large volumes of monitoring data. The data may include metrics such as node CPU utilization, memory utilization, request statistics, etc. which indicate system and application performance. Normally, system status is monitored using metric thresholds. If the value of a given metric is greater than (or less than) its upper (or lower) threshold, an alert will be triggered. An anomaly in a single metric, detected using a metric-specific threshold, is often insufficient to determine whether or not anomalous behavior has occurred or is occurring. For example, a high value of current CPU usage on a server may or may not indicate a problem. The alerts can therefore be inaccurate and/or meaningless, overwhelming development teams with unnecessary noise and obscuring actual incidents of concern.

Anomalous behavior of technical components (e.g., network adapters, containers) within a system landscape contributes negatively to the overall operational cost of the landscape. It is therefore desirable to efficiently detect anomalous behavior which occurs within a system landscape. As microservice environments become increasingly dynamic and scale to hundreds of thousands of hosts, it becomes exponentially difficult detect anomalies in time to prevent business-impacting issues from proliferating.

In theory, a classifier may be trained to detect anomalous behavior. However, due to the complexity of this task, a vast amount of labeled data is required to train a classifier to achieve the desired precision and recall. Labeling large data sets is expensive and requires expert knowledge. Moreover, anomalous behavior may be rare, acquisition of sufficient amounts of labeled data may be practically impossible.

Unsupervised clustering algorithms, such as K-means, avoid the labeling problems described above but present other shortcomings. A clustering algorithm divides data into clusters but cannot indicate which clusters represent anomalous behavior without separate data analysis. Moreover, changes to time-series data associated with the entities being observed results in cluster instability over time.

Systems are desired to efficiently identify anomalously-behaving entities from a set of homogeneous entities without requiring data labelling.

### BRIEF DESCRIPTION OF THE DRAWINGS

FIG. 1 illustrates a system to identify anomalously-behaving entities from dynamic data associated with a set of homogeneous entities according to some embodiments.

FIG. 2 is a tabular representation of time-series metric values for each of a set of homogeneous entities according to some embodiments.

FIG. 3 is a flow diagram of a process to identify anomalously-behaving entities from dynamic data associated with a set of homogeneous entities and to train a supervised learning system based on the dynamic data according to some embodiments.

FIG. 4 is a tabular representation of a representative metric value and a fluctuation value determined for each of a set of homogeneous entities according to some embodiments.

FIG. 5A illustrates determination of a standard metric value based on a distribution of representative metric values determined for each of a set of homogeneous entities according to some embodiments.

FIG. 5B illustrates determination of a standard fluctuation value based on a distribution of representative fluctuation values determined for each of a set of homogeneous entities according to some embodiments.

FIG. 6 is a tabular representation of differences between a standard metric value and a representative metric value determined for each of a set of homogeneous entities and differences between a standard fluctuation value and a fluctuation value determined for each of the set of homogeneous entities according to some embodiments.

FIG. 7 is a tabular representation of a composite difference determined for each of a set of homogeneous entities based on the FIG. 6 differences according to some embodiments.

FIG. 8 is a tabular representation of labeled time-series metric values for each of a set of homogeneous entities according to some embodiments.

FIG. 9 illustrates training of a classification system based on labeled time-series metric values for each of a set of homogeneous entities according to some embodiments.

FIGS. 10A and 10B comprise a flow diagram of a process to determine a standard metric value, a standard fluctuation value, and a composite difference for each of a set of homogeneous entities according to some embodiments.

FIG. 11 illustrates modifying values to change a statistical distribution of the values according to some embodiments.

FIG. 12 shows tabular representations of unmodified and modified representative values and fluctuation values according to some embodiments.

FIG. 13 is a tabular representation of difference values for each of a set of homogeneous entities according to some embodiments.

FIG. 14 is a tabular representation of normalized difference values and a composite difference value for each of a set of homogeneous entities according to some embodiments.

FIG. 15 is a block diagram of cloud-based servers of a system landscape providing anomalous behavior identification according to some embodiments.

### DETAILED DESCRIPTION

The following description is provided to enable any person in the art to make and use the described embodiments. Various modifications, however, will remain readily-apparent to those in the art.

Some embodiments operate to efficiently identify anomalous behavior based on time-series values of a metric for each of several entities. Embodiments may therefore employ intelligent self-learning to identify anomalous behavior with as little human intervention as possible. The entities may be homogeneous in that they each typically behave similarly with respect to the metric. Embodiments may relate to any types of entities, including but not limited to computer hardware, computer software, people, animals, structures, etc.

Generally, embodiments use the time-series data to determine eigenvalues and fluctuations for each entity, calculate standard points of eigenvalues and fluctuations, and identify heterogeneity (i.e., anomalous behavior) based on differences between the determined data and the standard points. Identified anomalous behavior may be aggregated/filtered based on different pre-defined/custom strategies for presentation (along with their corresponding time-series data, for example) to a development and operations (i.e., devops) team.

According to some embodiments, the time-series data may be labeled as anomalous or normal as determined above. Once a sufficiently-large set of data has been labeled, a classifier may be trained to identify anomalous behavior from new time-series data. The trained classifier may be then added to a production pipeline in lieu of the algorithm described above.

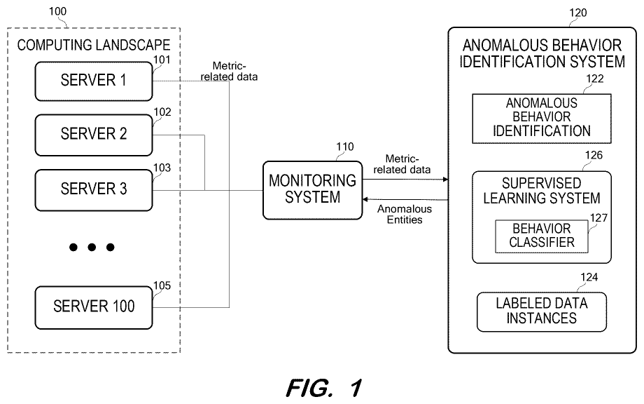

FIG. 1 illustrates a system according to some embodiments. The illustrated components of FIG. 1 may be implemented using any suitable combinations of computing hardware and/or software that are or become known. Such combinations may include cloud-based implementations in which computing resources are virtualized and allocated elastically. In some embodiments, two or more components are implemented by a single computing device.

Computing landscape 100 may comprise any number of hardware and software components which may provide functionality to one or more users (not shown). In the present example, computing landscape 100 may provide an application such as an online store and includes many servers 101-105 providing microservices of the application. Embodiments are not limited to a single application or to the components of landscape 100. Landscape 100 may comprise disparate cloud-based services, a single computer server, a cluster of servers, and any other combination that is or becomes known.

The hardware and software components of landscape 100 generate their own metric data and logs as is known in the art. Such data may be related to metrics associated with resource consumption (e.g., CPU utilization, memory utilization, bandwidth consumption), hardware performance (e.g., read/write speeds, bandwidth, CPU speed), application performance (e.g., queries served per second, number of simultaneous sessions), business performance (e.g., number of completed transactions, number of overseas orders), and any other metrics that are or become known. The data generated for each metric may comprise time-series data and may be generated at different respective time intervals.

Monitoring system 110 may comprise any suitable system to receive the metric-related data generated by the components of landscape 100. Monitoring system 110 may query landscape 100 for selected metric-related data, may subscribe to the selected metric-related data, may receive metric-related data pushed from landscape 100, or may acquire the metric-related therefrom using any suitable protocol. Monitoring system 110 may execute an application for recording real-time metric data in a time-series database using an HTTP pull model.

Monitoring system 110 provides time-series data of each of one or more metrics received from landscape 100 to anomalous behavior identification system 120. Monitoring system 110 may provide the data for one or more metrics (e.g., metrics M₀ to M₉) to system 120 as an independent time-series (e.g., M₀t₀, M₀t₁, . . . , M₀tₙ; M₁t₀, M₁t₁, . . . , M₁tₙ; . . . , M₀t₀, M₀t₁, . . . , M₀tₙ). In cases where the data is generated by landscape 100 at high sampling rates, and in order to reduce processing costs, monitoring system 110 may provide time-series data based on a reasonable time delta Δt (e.g., M₀t₀, M₀ (t₀+₁*Δt), M₀ (t₀+₂*Δt), . . . , M₀ (t₀+n*Δt)) if a higher sampling rate is not required for anomalous behavior identification. Embodiments are not limited thereto.

Computing landscape 100 may comprise a microservice-based cloud-native system utilizing a Kubernetes cluster. Kubernetes is an open-source system for automating deployment, scaling and management of containerized applications. Monitoring system 110 may therefore comprise Prometheus, a Kubernetes-compatible monitoring system which collects metrics for every service in the cluster and supports monitoring, processing and alerting applications.

Monitoring system 110 may perform any suitable processing on the metric-related data prior to providing the data to system 120, including but not limited to noise reduction and filtering. For example, monitoring system 110 may convert the time-series data into data instances, where each data instance includes values of a metric at a series of time points (e.g., [M₀t₀, M₀t₁, . . . , M₀t₉]; [M₁t₀, M₁t₁, . . . , M₁t₉]) . . . . Pre-processing may also or alternatively be performed by system 120. Conversely, the processes attributed herein to system 120 may be performed in whole or in part by monitoring system 110 according to some embodiments.

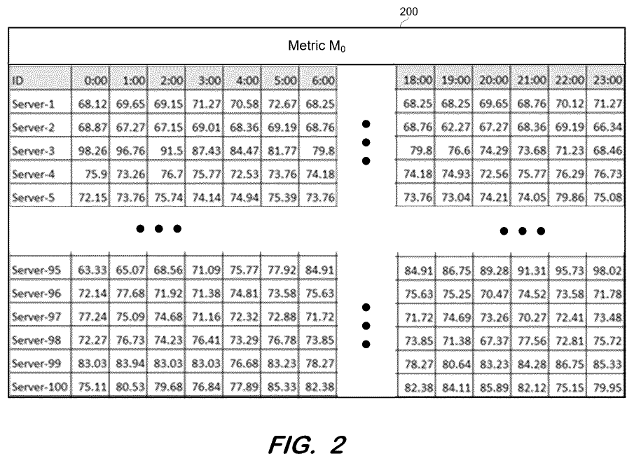

Anomalous behavior identification system 120 operates as described herein to identify anomalous behavior based on time-series data of a metric associated with each of several entities. FIG. 2 is a tabular representation of metric values 200 over time for each of a set of homogeneous entities according to some embodiments. The entities in the FIG. 2 example are computer servers (e.g., cloud-based virtual machines) and metric M₀ is memory utilization percentage. Embodiments may utilize any other metric, including metrics determined from two or more metrics.

Metric values 200 include, for each server, a value of metric M₀ for each of twenty-four time points which are one hour apart. Embodiments may use any number of time points at any time interval. According to some embodiments, each server includes similar hardware and software, and processes a similar workload. Such similarity may be preferable in order to create a scenario in which the metric values for each server over time are expected to be similar, allowing easier identification of dissimilar metric values and corresponding anomalous behavior.

System 120 includes anomalous behavior identification component 122, which may comprise program code stored on a non-transitory medium and executable by one or more processing units of system 120 to identify anomalous behavior based on the time-series data. For example, anomalous behavior identification component 122 may be executed to determine a representative value of a metric and a fluctuation value for each entity based on the time-series data, determine a standard value of the metric and a standard fluctuation value based on the representative values and the fluctuation values, and determine, for each entity, a difference value based on a difference between the standard value and the representative value for the entity and the difference between the standard fluctuation value and the fluctuation value for the entity. One or more anomalous entities are then identified based on the difference values.

According to some embodiments, anomalous behavior identification component 122 labels each set of the original time-series data based on whether the time-series data was determined to indicate anomalous or normal behavior. The labeled data is stored in labeled data instances 124. Supervised learning system 126 may train behavior classifier 127 to identify anomalous behavior based on labeled data instances 124.

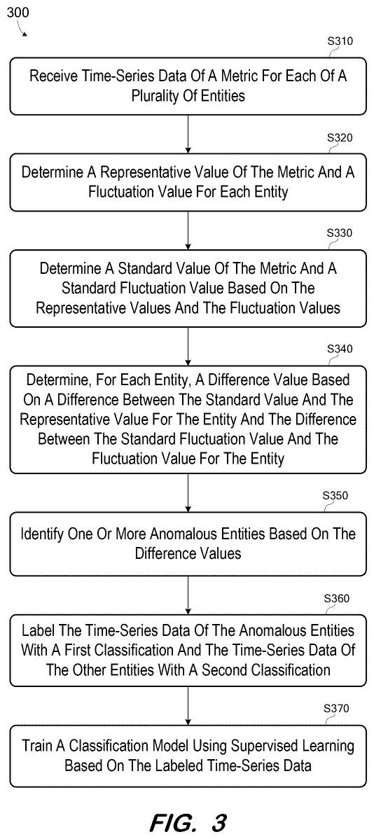

FIG. 3 comprises a flow diagram of process 300 to identify anomalously-behaving entities from dynamic data associated with a set of homogeneous entities and to train a supervised learning system based on the dynamic data according to some embodiments. Process 300 and the other processes described herein may be performed using any suitable combination of hardware and software. Software program code embodying these processes may be stored by any non-transitory tangible medium, including a fixed disk, a volatile or non-volatile random access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture. Embodiments are not limited to the examples described below.

Initially, at S310, time-series data of a metric is received for each of a plurality of entities. As described above, the entities may be homogeneous, i.e., similar to one another and operating under similar workloads. Computing systems may generate hundreds of metrics, many of which may be irrelevant to identification of anomalous behavior. The above-mentioned Prometheus system may collect and store time-series data at S310 of a metric such as CPU usage and quota, for memory usage and quota, for network usage, for JVM threads, etc.

Next, at S320 a representative value of a metric and a fluctuation value for each entity is determined based on the time-series data. The representative value of the metric for an entity may be a value which is expected to best represent the behavior of the entity with respect to the metric. In many instances, the representative value is the most-recent value of the metric, but embodiments are not limited thereto. The representative value may be considered an eigenvalue, i.e., a “characteristic” value. In the present example in which metric M₀ is memory utilization percentage, the representative value for an entity is the most-recent (i.e., associated with Time dimension member 23:00) value of metric M₀.

Fluctuation values may be indicative of behavior anomalies, either because of large fluctuation values or fluctuation values which are dissimilar from those of other homogeneous entities. According to some embodiments, a fluctuation value is determined for each entity using the formula for standard deviation σ,

$$σ = \sqrt{\frac{\sum {( {x}_{i} - μ )}^{2}}{N}} ,$$

where μ=the mean of all the metric values for the entity, xᵢ=the individual metric values for the entity, N=the number of metric values for the entity, and i=all the values from 1 to N. The standard deviation is a measure of the amount of variation or dispersion of a set of values. A low σ indicates that the values tend to be close to the mean of the values, while a high σ indicates that the values are spread out over a wider range. Measure other than the standard deviation may be used as the fluctuation according to some embodiments.

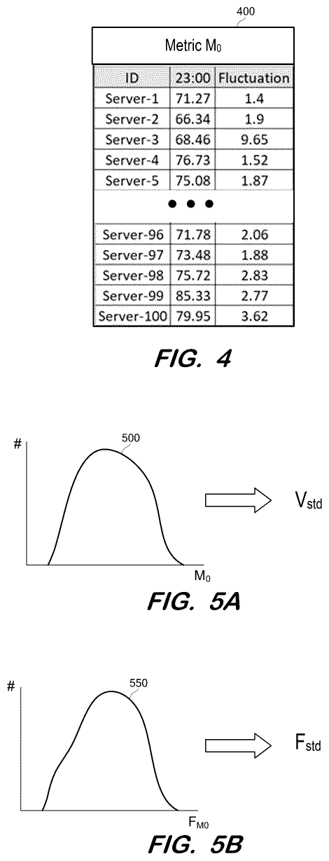

FIG. 4 illustrates table 400 including, for each of Server-1 through Server-100, a representative metric value (i.e., associated with dimension member 23:00) and a fluctuation value determined at S320 based on metric values 200.

Next, at S330, standard value of the metric and a standard fluctuation value are determined based on the representative values and fluctuation values determined at S320. FIG. 5a illustrates distribution 500 of the representative metric values determined at S320. The standard value V_{std} of the metric may be determined based on distribution 500 using any suitable technique. According to some examples, the standard value is determined based on the mean, median, and/or mode of distribution 500. In some embodiments, the representative metric values are modified in order to change the shape of distribution 500, and the standard value V_{std} is determined based on the mean, median, and/or mode of the modified representative metric values.

FIG. 5b illustrates distribution 550 of the fluctuation values determined at S320. As described above, the standard fluctuation value F_{std} may be determined at S330 based on distribution 550 using any suitable technique. In particular, the standard fluctuation value F_{std} may be determined based on the mean, median, and/or mode of distribution 550 or on the mean, median, and/or mode of a distribution of modified fluctuation values.

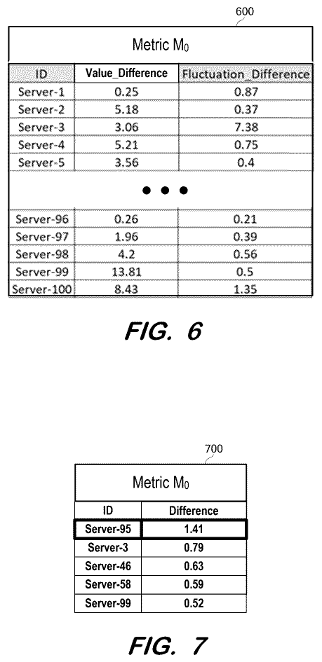

For each entity, a difference value is determined at S340 based on a difference between the standard value and the representative value for the entity and the difference between the standard fluctuation value and the fluctuation value for the entity. Table 600 of FIG. 6 illustrates, for each entity, a difference between the standard value V_{std} and the representative value for the entity (shown in table 400) and the difference between the standard fluctuation value F_{std} and the fluctuation value for the entity (also shown in table 400).

The difference value for each entity is determined based on the differences associated with the entity in table 600. Embodiments may utilize any suitable algorithm at S340 to generate a difference value based on two such differences. One algorithm according to some embodiments is described below. FIG. 7 shows table 700 including difference values determined at S340. The rows of table 700 have been sorted based on the difference values, from highest to lowest.

One or more anomalous entities are identified based on the difference values at S350. In some embodiments, the entities associated with the top Z difference values are identified at S350. In some embodiments of S350, outlier difference values are determined using any suitable approach, and entities which are associated with the outlier difference values are identified. Continuing the present example, Server-95 is identified at S350 due to the magnitude of its associated difference value and the large difference between the difference value and the next-highest difference values.

S350 may also or alternatively compare the difference values to a threshold and identify entities associated with a difference value greater than the threshold. According to some embodiments, a threshold is determined by sorting the difference values and determining the threshold as equal to the average of the top 5% of the sorted difference values. This implementation leverages the fact that 95% of the normal data will fall within two standard deviations of the distribution. In the FIG. 7 example, the threshold is determined to be 0.788 (i.e., the average of 1.41, 0.79, 0.63, 0.59 and 0.52). Accordingly, entities Server-95 and Server-3 are identified at S350.

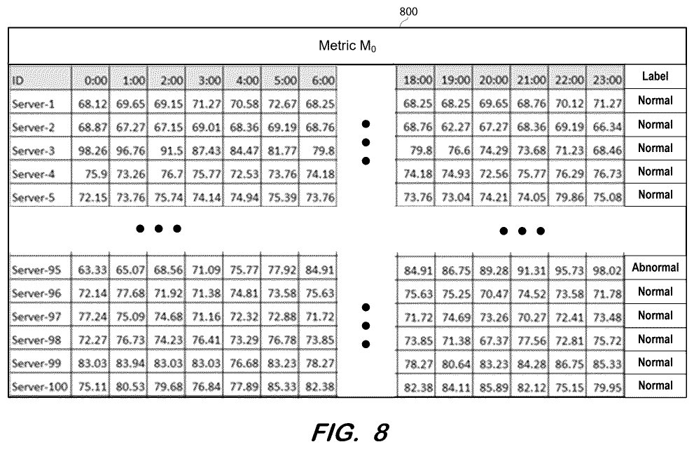

At S360, the time-series data associated with identified anomalous entities is labeled with a first classification (e.g., “anomalous”) and the time-series data of the other entities is labeled with a second classification (e.g., “normal”). FIG. 8 illustrates table 800 including time-series data 200 labeled at S360 according to some embodiments. Each row of table 800 may be considered a training data instance, including training data (i.e., the time-series of metric values) and a corresponding label.

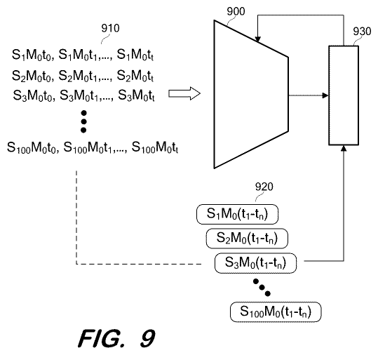

A classification model is trained at S370 based on the labeled time-series data. FIG. 9 illustrates the training of classification model 900 at S370 according to some embodiments. FIG. 9 shows rows of training data 910. Each training data instance includes a row of training data 910 and a corresponding label 920 as described above with respect to table 800. The label 920 corresponding to a given row of training data 910 indicates whether the time-series data of the row represents anomalous or normal behavior.

During training, rows of training data 910 are input to classification model 900, which outputs a classification for each row 910. Loss layer 930 compares the classification output for each row 910 with a label 920 corresponding to each row 910 to determine a total loss. The loss is back-propagated to model 900 which is modified based thereon. Training continues in this manner until satisfaction of a given performance target or a timeout situation. Classification model 900 may be a decision tree and may be trained at S370 using the XGBoost or LightGBM libraries, but embodiments are not limited thereto. After training, classification model 900 is able to infer whether or not new time-series data of metric values is indicative of anomalous behavior. The inference may be most reliable if the time-series data is associated with an entity and workload that is homogeneous with the entities and workloads associated with training data 910.

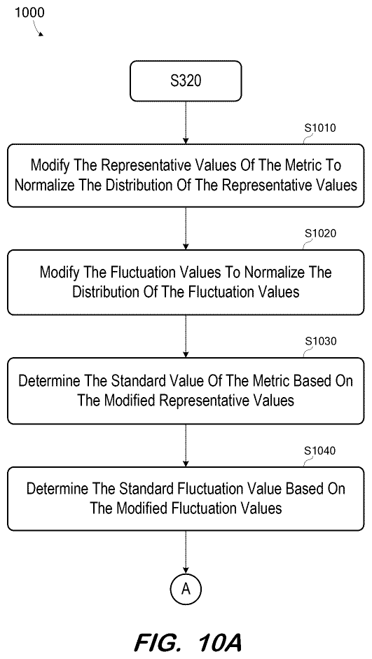

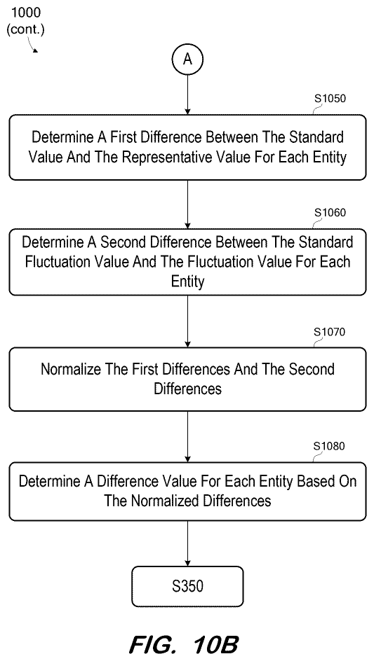

FIGS. 10A and 10B comprise a flow diagram of process 1000 to determine a standard metric value, a standard fluctuation value, and a composite difference value for each of a set of homogeneous entities according to some embodiments. Accordingly, process 1000 may comprise a particular implementation of S330 and S340 of process 300 described above, but neither process 1000 nor S330 and S340 are limited thereto.

It is initially assumed that a representative value of a metric and a fluctuation value has been determined for each of a plurality of entities. Next, at S1010, the representative values of the metric are modified to normalize the distribution of the representative values. FIG. 11 shows distribution 1110 of the representative values determined for each of the plurality of entities. Distribution 1110 is not a normal distribution, in that the mean, median and mode of distribution 1110 are not equal.

Winsorization may be applied to the representative values at S1010 to change the distribution of the representative values from distribution 1110 to a normal distribution such as distribution 1120. Generally, Winsorization is a method of averaging that initially replaces the smallest and largest values of a distribution with the values closest to them.

Winsorization limits the effect of outliers or abnormal extreme values, or outliers, on subsequent calculations. S1010 may implement any algorithm for modifying the representative values so that the distribution thereof changes to a more-normal distribution. Similarly, the fluctuation values are modified at S1020 to normalize the distribution of the fluctuation values.

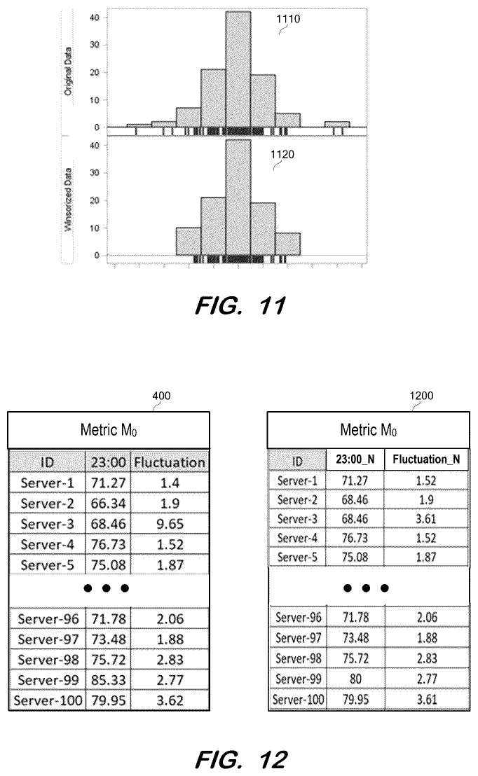

Table 1200 of FIG. 12 shows the modified representative values and the modified fluctuation values as compared to their original values from table 400 of FIG. 4. As shown, the representative values associated with some entities (e.g., Server-2, Server-99) were modified at S1010 while the representative values associated with other entities were not. At S1020, the fluctuation values associated with some entities (e.g., Server-1, Server-3, Server-100) were modified while the fluctuation values associated with other entities were not. In some examples, the representative value associated with a particular entity may be modified at S1010 and the fluctuation value associated with the particular entity may also be modified at S1020.

The standard value of the metric is determined at S1030 based on the modified representative values. According to this example, the standard value is determined based on the mean, mode and median of the modified representative values. Assuming the reliability of the median and the mode is higher than that of the mean in a homogeneous data set, S1030 may comprise determining the mean of the median and the mode, i.e., V_{std}=mean(median(V_{mod})+mode(V_{mod})). The standard fluctuation value may be determined similarly at S1040 based on the modified fluctuation values, F_{std}=mean(median(f_{mod})+mode(f_{mod})).

Next, at S1050, a first difference is determined between the standard value and the representative value for each entity. S1050 may comprise determining an absolute value of a difference between the representative value of an entity and the standard representative value V_{std}. S1060 includes determination of a second difference between the standard fluctuation value and the fluctuation value for each entity, for example by determining an absolute value of a difference between the fluctuation value of an entity and the standard fluctuation value F_{std}. Table 1300 of FIG. 13 shows the first difference and the second difference for each of the plurality of entities, as determined at S1050 and S1060 based on the values of table 400 and standard values V_{std} and F_{std}.

The first differences and the second differences are normalized to range between 0 and 1 at S1070. Embodiments may employ any other normalization range. Such normalization is intended to unify the magnitudes of the metric values and the fluctuation values, and thereby the magnitudes of the differences determined at S1050 and S1060. According to some embodiments, S1070 includes determining, for each of the first differences d₁,

$${d}_{1 i} = \frac{{d}_{1 i} - min ( {d}_{1} )}{max ( {d}_{1} ) - min ( {d}_{1} )}$$

and determining, for each of the second differences d₂,

$${d}_{2 i} = \frac{{d}_{2 i} - min ( {d}_{2} )}{max ( {d}_{2} ) - min ( {d}_{2} )} .$$

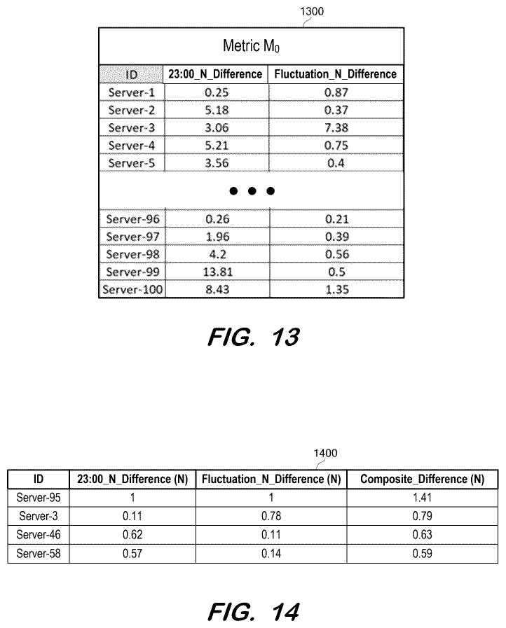

The first two columns of table 1400 of FIG. 14 show, respectively, the normalized first differences and normalized second differences for each entity. Next, at S1080, a difference value is determined for each entity based on the normalized first and second differences associated with the entity. The rightmost column of table 1400 shows such difference values, where the difference value of a given row is determined based on the normalized differences stored in the other cells of the given row.

Any suitable algorithm may be used to determine the difference values at S1080. According to some embodiments, the algorithm is as follows:

$$Difference value = \sqrt{Normalized First {Difference}^{2} + Normalized Second {Difference}^{2}}$$

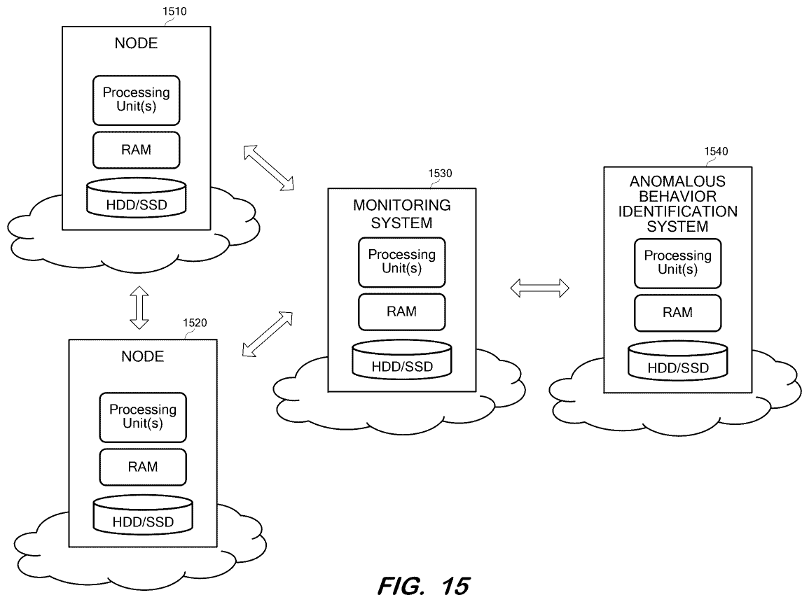

FIG. 15 illustrates a cloud-based database deployment according to some embodiments. The illustrated components may comprise cloud-based compute resources residing in one or more public clouds providing self-service and immediate provisioning, autoscaling, security, compliance and identity management features.

Nodes 1510 and 1520 may comprise servers or virtual machines of a Kubernetes cluster. Nodes 1510 and 1520 may support containerized applications which provide one or more services to users. In this regard, nodes 1510 and 1520 may comprise an implementation of landscape 100. Monitoring system 1530 receives metric-related time-series data from each of nodes 1510 and 1520 as is known in the art. Anomalous behavior identification system 1540 receives this data (or a subset) thereof from monitoring system 1530. Anomalous behavior identification system 1540 may operate as described herein to identify anomalous behavior based on the received time-series data.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a hard disk, a DVD-ROM, a Flash drive, magnetic tape, and solid-state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a memory storing processor-executable program code; and
at least one processing unit to execute the processor-executable program code to cause the system to:
receive time-series data of a metric for each of a plurality of computer servers;
for each computer server, determine a representative value of the metric based on the time-series data of the metric for the computer server;
for each computer server, determine a fluctuation value of the metric based on the time-series data of the metric for the computer server;
determine a standard value of the metric based on the determined representative values;
determine a standard fluctuation value based on the determined fluctuation values;
for each computer server, determine a difference value based on a difference between the standard value and the representative value for the computer server and a difference between the standard fluctuation value and the fluctuation value for the computer server; and
identify one or more anomalous computer servers based on the difference values.

2. A system according to claim 1, the at least one processing unit to execute the processor-executable program code to cause the system to:
label the time-series data of the anomalous computer servers with a first classification and the time-series data of the other ones of the plurality of computer servers with a second classification; and
train a classification model using supervised learning based on the labeled time-series data.

3. A system according to claim 2, wherein determination of the standard value of the metric based on the determined representative values comprises:
modification of the representative values to normalize the distribution of the representative values; and
determination of the standard value of the metric based on the modified representative values.

4. A system according to claim 3, wherein determination of the fluctuation value based on the determined fluctuation values comprises:
modification of the fluctuation values to normalize the distribution of the fluctuation values; and
determination of the standard fluctuation value based on the modified fluctuation values.

5. A system according to claim 1, wherein determination of the standard value of the metric based on the determined representative values comprises:
modification of the representative values to normalize the distribution of the representative values; and
determination of the standard value of the metric based on the modified representative values.

6. A system according to claim 5, wherein determination of the fluctuation value based on the determined fluctuation values comprises:
modification of the fluctuation values to normalize the distribution of the fluctuation values; and
determination of the standard fluctuation value based on the modified fluctuation values.

7. A system according to claim 1, wherein determination of the difference value for each entity comprises:
normalization of the differences between the standard value and the representative value for the computer server and the differences between the standard fluctuation value and the fluctuation value for the computer server; and
determination of the difference value for each entity based on the normalized differences.

8. A computer-implemented method comprising:
receiving time-series data of a metric for each of a plurality of computer servers;
for each computer server, determining a representative value of the metric based on the time-series data of the metric for the computer server;
for each computer server, determining a fluctuation value of the metric based on the time-series data of the metric for the computer server;
determining a standard value of the metric based on the determined representative values;
determining a standard fluctuation value based on the determined fluctuation values;
for each computer server, determining a difference between the standard value and the representative value for the computer server and a difference between the standard fluctuation value and the fluctuation value for the computer server; and
identify one or more anomalous computer servers based on the determined differences.

9. A method according to claim 8, further comprising:
labelling the time-series data of the anomalous computer servers with a first classification and the time-series data of the other ones of the plurality of computer servers with a second classification; and
training a classification model using supervised learning based on the labeled time-series data.

10. A method according to claim 9, wherein determining the standard value of the metric based on the determined representative values comprises:
modifying the representative values to normalize the distribution of the representative values; and
determining the standard value of the metric based on the modified representative values.

11. A method according to claim 10, wherein determining the fluctuation value based on the determined fluctuation values comprises:
modifying the fluctuation values to normalize the distribution of the fluctuation values; and
determining the standard fluctuation value based on the modified fluctuation values.

12. A method according to claim 8, wherein determining the standard value of the metric based on the determined representative values comprises:
modifying the representative values to normalize the distribution of the representative values; and
determining the standard value of the metric based on the modified representative values.

13. A method according to claim 12, wherein determining the fluctuation value based on the determined fluctuation values comprises:
modifying the fluctuation values to normalize the distribution of the fluctuation values; and
determining the standard fluctuation value based on the modified fluctuation values.

14. A method according to claim 8, further comprising:
normalizing the differences between the standard value and the representative value for the computer server and the differences between the standard fluctuation value and the fluctuation value for the computer server; and
determining a difference value for each entity based on the normalized differences,
wherein the one or more anomalous computer servers are identified based on the determined difference values.

15. A computer-readable medium storing processor-executable program code, the program code executable by a computing system to:
receive time-series data of a metric for each of a plurality of computer servers;
for each computer server, determine a representative value of the metric based on the time-series data of the metric for the computer server;
for each computer server, determine a fluctuation value of the metric based on the time-series data of the metric for the computer server;
determine a standard value of the metric based on the determined representative values;
determine a standard fluctuation value based on the determined fluctuation values;
for each computer server, determine a difference value based on a difference between the standard value and the representative value for the computer server and a difference between the standard fluctuation value and the fluctuation value for the computer server; and
identify one or more anomalous computer servers based on the difference values.

16. A medium according to claim 15, the program code executable by a computing system to:
label the time-series data of the anomalous computer servers with a first classification and the time-series data of the other ones of the plurality of computer servers with a second classification; and
train a classification model using supervised learning based on the labeled time-series data.

17. A medium according to claim 16, wherein determination of the standard value of the metric based on the determined representative values comprises:
modification of the representative values to normalize the distribution of the representative values; and
determination of the standard value of the metric based on the modified representative values.

18. A medium according to claim 17, wherein determination of the fluctuation value based on the determined fluctuation values comprises:
modification of the fluctuation values to normalize the distribution of the fluctuation values; and
determination of the standard fluctuation value based on the modified fluctuation values.

19. A medium according to claim 15, wherein determination of the standard value of the metric based on the determined representative values comprises:
modification of the representative values to normalize the distribution of the representative values; and
determination of the standard value of the metric based on the modified representative values.

20. A system according to claim 15, wherein determination of the difference value for each entity comprises:
normalization of the differences between the standard value and the representative value for the computer server and the differences between the standard fluctuation value and the fluctuation value for the computer server; and
determination of the difference value for each entity based on the normalized differences.
